(19) United States
(12) Patent Application Publication
(10) Pub. No.: US 2012/0228548 A1
(43) Pub. Date: Sep. 13, 2012

(54) MOISTURE CONTROL CONSTRUCTION MATERIAL AND METHOD FOR PRODUCING THE SAME

(75) Inventors: Shuji KAWAI, Tokyo (JP); Michihiro TAKEDA, Tokyo (JP); Yoshiaki HIRASAWA, Tokyo (JP)

(73) Assignee: LIXIL CORPORATION, Tokyo (JP)

(21) Appl. No.: 13/365,900

(22) Filed: Feb. 3, 2012

(30) Foreign Application Priority Data
Mar. 9, 2011 (JP) 2011-051518

(51) Int. Cl. C09K 3/00

(52) U.S. Cl. 252/194

(57) ABSTRACT

Provide is a moisture control construction material which has improved moisture control performance and strength and which is easily produced, and a method for producing the same. The moisture control construction material is produced by forming a raw material that contains aluminum hydroxide and bentonite and/or montmorillonite, and firing the formed: raw material at 700° C. to 1100° C. The raw material contains 30% to 97% by weight aluminum hydroxide and 3% to 70% by weight bentonite and/or montmorillonite, or contains 30% to 90% by weight aluminum hydroxide, 1% to 30% by weight bentonite and/or montmorillonite, and 5% to 69% by weight clay.

### TECHNICAL FIELD

The present invention relates to a moisture control construction material made from aluminum hydroxide serving as a raw material and a method for producing the same, and more particularly, to a moisture control construction material to which strength is imparted while the moisture control properties of a fired article of aluminum hydroxide are maintained, and to a method for producing the same.

### BACKGROUND ART

Dehydrated aluminum hydroxide produced by heat treatment of an aluminum hydroxide powder has moisture absorbing and desorbing properties. Thus, a moisture control construction material produced by adding additives to aluminum hydroxide, subjecting the mixture to mixing, forming, and firing is reported.

Patent Literature 1 (Japanese Patent Publication 2001-122657) describes a moisture control construction material produced as follows: Aluminum hydroxide and clay are mixed in such a manner that the resulting mixture has a chemical composition of 33% to 76% by weight of Al₂O₃, 15% to 57% by weight of S10₂, 5% by weight or less of the total amount of Na₂O, K₂O, Li₂O, B₂O₃, and 9% by weight or less of the total amount of P₂O₅, CaO, BaO, and MgO. The mixture is mixed and formed. Then the formed article is fired in such a manner that the main peak of k-Al₂O₃ is detected in an X-ray diffraction chart and that the height of the main peak of k-Al₂O₃ is greater than that of α-Al₂O₃.

In Patent Literature 1, the moisture absorbing and desorbing properties of alumina (aluminum oxide) produced by the dehydration of aluminum hydroxide is utilized, and the sintering-enhancing effect of the clay used together with the raw material aluminum hydroxide allows a fired article (sintered body) to have high strength.

Patent Literature 2 (Japanese Patent Publication 2002-249372) describes that materials containing aluminum hydroxide, a kaolin powder, and water glass are mixed, formed, and fired to produce a moisture control construction material.

In Patent Literature 2, the incorporation of the water glass into the materials allows the moisture control construction material to have enhanced strength.

### CITATION LIST

[PTL 1] Japanese Patent Publication 2001-122657

[PTL 2] Japanese Patent Publication 2002-249372

The dehydration of aluminum hydroxide by firing brings about a porous state in which a large number of pores are present. The pores provide excellent moisture control performance. Such an aluminum hydroxide-based moisture control construction material is porous and thus is brittle. For example, in the case where the moisture control construction material is used for wall surfaces, the minute cracking and motion of a framework produce cracks. It is thus necessary to increase the strength without considerably reducing the moisture control performance.

In Patent Literature 1, the incorporation of the clay into the materials results in the tight binding of dehydrated aluminum hydroxide to increase the strength while the collapse of micropores in the dehydrated aluminum hydroxide due to sintering is inhibited. In Patent Literature 2, the water glass melts at a low temperature and solidifies dehydrated aluminum hydroxide to increase the strength.

However, higher proportions of clay and water glass in the materials result in a relative reduction in the amount of aluminum hydroxide in the materials, thereby reducing moisture control performance. In the case where water glass is incorporated, water glass melts at the time of firing and clogs pores that control moisture, thereby reducing the moisture control performance. Furthermore, in the case where water glass is used, a powder to be compacted is sticky; hence, the powder adheres to a mold at the time of compacting, reducing productivity.

### OBJECT OF INVENTION

It is an object of the present invention to provide a moisture control construction material which has improved moisture control performance and strength and which is easily produced, compared with the moisture control construction materials described in Patent Literatures 1 and 2, and a method for producing the moisture control construction material.

### SUMMARY OF INVENTION

A moisture control construction material according to aspect 1 is produced by forming a raw material that contains aluminum hydroxide and bentonite and/or montmorillonite, and firing the formed raw material.

According to aspect 2, in the moisture control construction material according to aspect 1, the raw material contains 30% to 97% by weight aluminum hydroxide and 3% to 70% by weight bentonite and/or montmorillonite.

According to aspect 3, in the moisture control construction material according to aspect 1, the raw material contains 30% to 90% by weight aluminum hydroxide, 1% to 30% by weight bentonite and/or montmorillonite, and 5% to 69% by weight clay.

A method for producing a moisture control construction material according to aspect 4 includes forming a raw material that contains aluminum hydroxide and bentonite and/or montmorillonite, and firing the formed raw material at 700° C. to 1100° C.

According to aspect 5, in the method for producing a moisture control construction material according to aspect 4, the raw material contains 30% to 97% by weight aluminum hydroxide and 3% to 70% by weight bentonite and/or montmorillonite.

According to aspect 6, in the method for producing a moisture control construction material according to aspect 4, the raw material contains 30% to 90% by weight aluminum hydroxide, 1% to 30% by weight bentonite and/or montmorillonite, and 5% to 69% by weight clay.

According to aspect 7, in the method for producing a moisture control construction material according to any one of aspects 4 to 6, at least part of the raw material is calcined.

### Advantageous Effects of Invention

Aluminum hydroxide is dehydrated by firing at about 300° C. to 500° C. to become porous, thereby providing moisture control properties. However, the porous aluminum hydroxide does not have strength sufficient for construction materials. In the case where aluminum hydroxide is sintered at a high temperature in order to increase the strength, the moisture control properties disappear. In Patent Literature 1, the incorporation of clay into aluminum hydroxide provides the strength owing to the fixing effect of the clay while the moisture control properties of dehydrated aluminum hydroxide are ensured. Bentonite used in the present invention has a higher fixing strength than clay and thus tightly fixes dehydrated aluminum hydroxide, thereby enabling the moisture control construction material to have high strength.

Furthermore, bentonite is a layer mineral in which H₂O intervenes between layers. Bentonite is fired to release a large amount of interlayer water at about 600° C., thereby providing a collapsed structure. The entanglement of dehydrated aluminum hydroxide with the dehydrated bentonite having the structure facilitates the maintenance of the porous state of the dehydrated aluminum hydroxide. In addition, bentonite is not melted by firing at about 700° C. to 1100° C. and thus does not clog micropores of the dehydrated aluminum hydroxide, thus leading to high moisture control performance of the moisture control construction material.

In the present invention, the presence of bentonite and/or montmorillonite inhibits the α-alumina crystallization reaction of the dehydrated aluminum hydroxide. Most of the dehydrated material (aluminum oxide) remains porous. Furthermore, proportions of glass-forming components, such as Na₂O, K₂O, Li₂O, B₂O₃, P₂O₅, and BaO, are low; hence, clogging of the pores by the formation of a glass melt can be inhibited.

According to the present invention, combinations of these factors provide high strength and moisture absorbing and desorbing properties, compared with aluminum hydroxide alone.

Furthermore, the incorporation of bentonite and/or montmorillonite into the raw material improves formability and formativeness at the time of forming.

Moreover, the inventors have conducted intensive studies and have found that the incorporation of clay and bentonite and/or montmorillonite into the raw material provides a moisture control construction material having high moisture control performance and high strength, compared with Patent Literature 1 in which only aluminum hydroxide and clay are used. A higher bentonite and/or montmorillonite content results in an increase in firing shrinkage. However, the incorporation of clay enables the firing shrinkage to be adjusted, thereby facilitating the dimensional adjustment of a construction material.

### Description of Embodiments

To produce a moisture control construction material of the present invention, aluminum hydroxide, bentonite and/or montmorillonite, and, if necessary, clay are mixed together, formed, and fired.

As aluminum hydroxide, powdery aluminum hydroxide is preferred. Aluminum hydroxide may have any form, for example, gibbsite, bayerite, boehmite, diaspore, alumina sol, or alumina gel. Note that various aluminum compounds, such as aluminum chloride and aluminum nitride, which become porous by firing, may also be used. However, the hydroxide is most preferred.

Bentonite is a mineral that is mainly composed of montmorillonite and is often accompanied with quartz, cristobalite, feldspars, carbonate minerals, and so forth. Typical examples thereof include Na bentonite and Ca bentonite containing Na montmorillonite and Ca montmorillonite; acid clay formed when bentonite is weathered; and activated clay formed by the treatment of the acid clay.

As the clay, various clays containing kaolin minerals, such as kibushi clay, gairome clay, fire clay, stoneware clay, and kaolin, may be used.

The compounding ratio of the materials preferably falls within the following ranges: 30% to 97% by weight and particularly 40% to 60% by weight of, aluminum hydroxide, 1% to 70% by weight and particularly 3% to 20% by weight of bentonite and/or montmorillonite, and 0% to 69% by weight and particularly 0% to 55% by weight of clay. Furthermore, the composition of a fired moisture control construction material preferably falls within the following ranges.

Al₂O₃: 30% to 95% by weight and particularly 40% to 80% by weight

SiO₂: 3% to 65% by weight and particularly 15% to 50% by weight

The total of CaO and MgO: 10% by weight or less and particularly 3% by weight or less

Flux (the total of Na₂O, K₂O, Li₂O, B₂O₃, P₂O₅, and BaO): 5% by weight or less and particularly 3% by weight

A SiO₂ content exceeding 65% by weight results in the degradation of the sinterability of the raw material and results in an excessively low Al₂O₃ content to degrade the moisture control properties. A SiO₂ content of less than 3% by weight results in a reduction in the strength of a sintered body. In this case, an excessively small amount of bentonite and/or montmorillonite, or clay leads to a reduction in formability.

A total amount of CaO and MgO exceeding 10% by weight results in clogging of micropores in the moisture control construction material are clogged to reduce the moisture control properties. A flux content exceeding 5% by weight results in clogging of micropores of the moisture control construction material, thereby reducing the moisture control properties.

In the present invention, sintering-aid components, such as various glass powders and frits, sheet glasses for buildings and automobiles, and various slags, e.g., municipal-waste molten slag and steelmaking slag, may be incorporated as long as the moisture control properties and strength of the moisture control construction material are not adversely affected. The sintering-aid component content is preferably 50 parts by weight or less and particularly 30 parts by weight or less with respect to 100 parts by weight of aluminum hydroxide, bentonite and/or montmorillonite, and clay.

At least some of the materials, for example, at least one of aluminum hydroxide, bentonite and/or montmorillonite, and clay, may be calcined at a temperature (e.g., about 500° C. to 800° C.) lower than a firing temperature described below. Calcination of the materials increases the activity of the materials, thus improving the firing properties. Furthermore, in the case where materials, such as aluminum hydroxide and clay, which will be dehydrated at the time of firing, and a material that will be decarboxylated at the time of firing are calcined, rapid dehydration and decarboxylation at the time of firing are prevented. This prevents, for example, the cracking of the resulting fired article.

After the foregoing materials are optionally pulverized, the materials are mixed together and formed. A pulverization method, a mixing method, and a forming method are not particularly limited. Examples of the forming method include press forming and extrusion molding. A forming aid, such as methyl cellulose, may be added for the forming. A moisture control construction material may have an appropriate shape, such as a plate shape, a block shape, or a tubular shape.

A formed article is optionally dried and then fired at preferably 700° C. to 1100° C. and particularly 750° C. to 1000° C. for 0.2 to 100 hours and preferably 0.3 to 72 hours.

This provides a moisture control construction material having a bending strength of 3 MPa or more, in which when the moisture control construction material having a constant weight in an atmosphere having a relative humidity of 50% at 25° C. is brought into contact with air having a relative humidity of 90% at 25° C. for 24 hours, the amount of moisture absorbed is 150 g/m² or more.

In the present invention, values of the bending strength, the amount of moisture absorbed and so forth are determined by methods described below.

Bending strength: The bending strength is determined by a three-point bending method.

Moisture absorbing performance: After a moisture control construction material whose back face and end faces are sealed with an aluminum tape is placed in a thermo-hygrostat having a relative humidity of 50% at 25° C. until the weight of the moisture control construction material is not changed (until variations in weight is 0.1% or less), the moisture control construction material is placed in a thermo-hygrostat having a relative humidity of 90% at 25° C. After 24 hours, an increase in weight and dimensions of a specimen are measured. The amount of moisture absorbed in terms of a unit area (1 m²) is defined as an index.,

In the present invention, a surface of a moisture control construction material may be subjected to application of a light coating of a glaze to enhance design quality and stain resistance. In this case, in order not to impair the moisture control properties, the application is preferably performed in such a manner that a glass layer made from the glaze is formed in a region having an area 90% or less of the surface area of the main body of the moisture control construction material or the glass layer has a maximum thickness of 300 μm or less.

### EXAMPLES

### Example 1

After 50 parts by weight of industrial aluminum hydroxide (Al(OH)₃, grade: 99.6% purity), 10 parts by weight of bentonite (from Annaka, Gunma-ken), and 40 parts by weight of clay (from Seto, Aichi-ken) were pulverized and mixed in a ball mill, the mixture was subjected to press forming to form a 110×110×5.5 mm formed article. The formed article was fired at 800° C. for 1.0 hour, thereby producing a moisture control construction material.

Table 1 shows the measurement results of the chemical composition, the amount of moisture absorbed, the bending strength, and the processability of the moisture control construction material.

Note that the processability indicates a cut length for 30 seconds when a man cuts the moisture control construction material with a wood saw at a normal working speed.

### Examples 2 to 6 and Comparative Examples 1 to 6

Moisture control construction materials were produced as in Example 1, except that the compounding ratios of the materials and firing temperatures were set as described in Table 1 and that in Example 6, aluminum hydroxide was calcined at 500° C. and then pulverized and mixed with other materials. The same measurements were performed. Table 1 shows the results. In Comparative Examples 1, 2, and 7, the fired articles were not handled. Thus, the processability and the bending strength were not measured. The moisture control construction material according to Comparative Example 4 is the same as in Patent Literature The waste glass used in Comparative Example 9 is a waste article, such as bottle glass.

TABLE 1

| | | | | | | Amount of | | |
|---|---|---|---|---|---|---|---|---|
| | Raw material | | | | Firing | moisture | | |
| | Aluminum | | | Additional | temperature | absorbed | Bending strength | Processability |
| No. | hydroxide | Bentonite | Clay | component | (° C.) | (g/m²) | (MPa) | (mm/30 seconds) |
| Comparative | 100 | | | | 1000 | 300 | unmeasurable | unmeasurable |
| Example 1 | | | | | | | because of its high | because of its high |
| | | | | | | | fragility | fragility |
| Comparative | 100 | | | | 1100 | 170 | unmeasurable | unmeasurable |
| Example 2 | | | | | | | because of its high | because of its high |
| | | | | | | | fragility | fragility |
| Comparative | 25 | | 75 | | 800 | 321 | 4.5 | 80 |
| Example 3 | | | | | | | | |
| Comparative | 40 | | 60 | | 800 | 480 | 2.6 | 90 |
| Example 4 | | | | | | | | |
| Comparative | 50 | | 50 | | 800 | 639 | 2.5 | 155 |
| Example 5 | | | | | | | | |
| Comparative | 55 | | 45 | | 800 | 657 | 2.3 | 100 |
| Example 6 | | | | | | | | |
| Comparative | 85 | | 15 | | 800 | 831 | 0.5 | unmeasurable |
| Example 7 | | | | | | | | because of its high |
| | | | | | | | | fragility |
| Comparative | 60 | | | 40(kaolin clay) | 800 | 500 | 4.0 | 150 |
| Example 8 | | | | 10(water glass) | | | | |
| Comparative | 50 | | 40 | 10(waste glass) | 800 | 565 | 4.3 | 201 |
| Example 9 | | | | | | | | |
| Example 1 | 50 | 10 | 40 | | 800 | 605 | 5.0 | 210 |
| Example 2 | 55 | 7.5 | 37.5 | | 800 | 671 | 3.9 | 244 |
| Example 3 | 55 | 15 | 30 | | 800 | 590 | 4.7 | 262 |
| Example 4 | 40 | 15 | 45 | | 800 | 470 | 4.0 | 100 |
| Example 5 | 85 | 15 | | | 800 | 803 | 3.1 | 286 |
| Example 6 | 85 | 15 | | | 800 | 800 | 3.0 | 290 |

In Comparative Example 4 (Patent Literature 1), the use of fixing of clay provides a moisture control construction material, in which the bending strength is 2.6 MPa and the moisture control performance is 657 g/m². In contrast, in Example 4 in which bentonite is used, a high-strength moisture control construction material is provided, in which the moisture control performance is 470 g/m², which is comparable to that in Comparative Example 4, and the bending strength is 4.0 MPa, which is about 1.5 times that in Comparative Example 4. In Comparative Examples 3, 4, _{5, 6,} and 7, in which the amounts of aluminum hydroxide are increased, and Patent Literature 1, although the moisture control performance is improved, the strength is significantly reduced. In contrast, with respect to Examples 4, 1, 2, 3, and 6, in which bentonite is incorporated and in which the amounts of aluminum hydroxide are increased to enhance the moisture control properties, a strength of 3 MPa or more is obtained. That is, it is possible to produce the moisture control construction materials having high moisture control properties, which are not produced in Patent Literature 1. This is presumably because the high fixing strength of bentonite results in the binding of amorphous dehydrated aluminum hydroxide to provide the strength.

In the cases where glass is incorporated into aluminum hydroxide as in Comparative Example 9 and where water glass is incorporated into aluminum hydroxide as in Comparative Example 8, although the strength is increased to 4.0 MPa or more, the moisture control properties are reduced to 565 g/m² in Comparative Example 9 and 500 g/m² in Comparative Example 8, because the glass melts to clog pores. In contrast, in each of Examples 1, 2, and 3 in which bentonite is used according to the present invention, the moisture control performance is 590 g/m² or more, and both the strength and moisture control properties are excellent.

Example 6 demonstrates that even when the raw material is calcined, a similar excellent moisture control construction material is also produced.

As is clear from the foregoing examples and comparative examples, according to the present invention, the moisture control construction material having high strength and excellent moisture control properties is provided.

While the present invention has been described in detail using the specific embodiments, it will be obvious to those skilled in the art that various changes may be made without departing from the spirit and the scope of the invention.

This application is based on Japanese Patent Application No. 2011-51518 filed Mar. 9, 2011, which is hereby incorporated by reference herein in its entirety.

1. A moisture control construction material produced by forming a raw material that contains aluminum hydroxide and bentonite and/or montmorillonite, and firing the formed raw material.

2. The moisture control construction material according to claim 1, wherein the raw material contains 30% to 97% by weight aluminum hydroxide and 3% to 70% by weight bentonite and/or montmorillonite.

3. The moisture control construction material according to claim 1, wherein the raw material contains 30% to 90% by weight aluminum hydroxide, 1% to 30% by weight bentonite and/or montmorillonite, and 5% to 69% by weight clay.

4. A method for producing a moisture control construction material comprising forming a raw material that contains aluminum hydroxide and bentonite and/or montmorillonite, and firing the formed raw material at 700° C. to 1100° C.

5. The method for producing a moisture control construction material according to claim 4, wherein the raw material contains 30% to 97% by weight aluminum hydroxide and 3% to 70% by weight bentonite and/or montmorillonite.

6. The method for producing a moisture control construction material according to claim 4, wherein the raw material contains 30% to 90% by weight aluminum hydroxide, 1% to 30% by weight bentonite and/or montmorillonite, and 5% to 69% by weight clay.

7. The method for producing a moisture control construction material according to claim 4, wherein at least part of the raw material is calcined.
